(19) United States
(12) Patent Application Publication
(10) Pub. No.: US 2017/0091041 A1
(43) Pub. Date: Mar. 30, 2017

(54) METHOD AND APPARATUS FOR TRANSFERRING DATA BETWEEN DATABASES

(71) Applicant: ALIBABA GROUP HOLDING LIMITED, George Town (KY)

(72) Inventor: Peng LIU, Hangzhou (CN)

(73) Assignee: ALIBABA GROUP HOLDING LIMITED

(21) Appl. No.: 15/274,064

(22) Filed: Sep. 23, 2016

(30) Foreign Application Priority Data
Sep. 25, 2015 (CN) 201510623882.1

(51) Int. Cl. G06F 11/14; G06F 17/30

(52) U.S. Cl. CPC G06F 11/1402; G06F 17/30339; G06F 2201/80; G06F 17/30575

(57) ABSTRACT

A method and an apparatus for transferring data between a plurality of databases are provided. The method comprises: acquiring, by a read plug-in, data from a source database based on first configuration information that include information related to a location of the data in the source database; loading a set of preset routing rules; determining a target database and a target table based on the set of preset routing rules; and writing, by a write plug-in, the data into the target table in the target database based on second configuration information that include information related to a type of the target database and an identification of the target database.

### CROSS-REFERENCE TO RELATED APPLICATION

This application is based upon and claims priority to Chinese Patent Application No. 201510623882.1, filed Sep. 25, 2015, the entire contents of which are incorporated herein by reference.

### TECHNICAL FIELD

The present disclosure generally relates to the field of computer technology and, more particularly, to a method and an apparatus for transferring data between databases.

### BACKGROUND

With the rapid development of the Internet, the volume of data traffic has grown exponentially. Large-scale data processing systems, such as distributed data processing systems, have been developed to handle the ever-growing data traffic.

In a large-scale data processing system, certain valuable data may be generated and stored in a database (e.g., a data warehouse). That valuable data may be transferred, in a process of data backflow, from one database to another database, which may then provide the valuable data for other operations. That valuable data may become backflow data.

Reference is now made to FIG. 1, which illustrates a data backflow process 100 under the current technology. As shown in FIG. 1, data may be transmitted to a plurality of databases and tables according to a set of routing rules. The routing rules may be maintained by a service system that has access to the data storage. Based on the routing rules, the service system may divide the backflow data into a plurality of data portions, and store the data portions at the one or more tables associated with the databases (e.g., tables A1 and A2 of database A, and tables B1 and B2 of database B, etc.) according to the routing rules. Each data portion may correspond to a table of a database.

Under current technology, the routing rules for data backflow are typically expressed in the Groovy programming language, which are then translated into a set of self-defined functions associated with a big data processing system (e.g., Hadoop, Open Data Processing Service (ODPS), etc.). The translation process is usually tedious.

Moreover, the set of functions translated typically creates a plurality of new tables for the data portions, and copies each data portion to a new table. Given that each table includes multiple partitions, with each partition mapped to a single table of a single database, such an arrangement may lead to waste of database resources.

Further, the data backflow process is usually set up based on the sub-table and sub-database organization. For example, a data backflow process may be configured to transmit the data in a partition to a single table of a single database. The data backflow processes may be executed in a batch mode using a shell script. However, under the current technologies, the number of data backflow processes for transmission of the backflow data may be equal to the number of tables that correspond to the backflow data, and may be very large. As a result, the configuration of the data backflow processes may become complicated and tedious. This often leads to errors.

### SUMMARY

In one aspect, a method of transferring data between a plurality of databases is provided. The method comprises: acquiring, by a read plug-in, data from a source database based on first configuration information that include information related to a location of the data in the source database; loading a set of preset routing rules; determining a target database and a target table based on the set of preset routing rules; and writing, by a write plug-in, the data into the target table in the target database based on second configuration information that include information related to a type of the target database and an identification of the target database.

In another aspect, an apparatus for transferring data between a plurality of databases is provided. The apparatus comprises: a memory that stores a set of instructions; and at least one hardware processors configured to execute the set of instructions to: acquire, by a read plug-in, data from a source database based on first configuration information that include information related to a location of the data in the source database; load a set of preset routing rules; determine a target database and a target table based on the set of preset routing rules; and write, by a write plug-in, the data into the target table in the target database based on second configuration information that include information related to a type of the target database and an identification of the target database.

In yet another aspect, a non-transitory computer readable medium is provided. The non-transitory computer readable medium stores a set of instructions that is executable by at least one processor of an apparatus to cause the apparatus to perform a method for transferring data between a plurality of databases, the method comprising: acquiring, by a read plug-in, data from a source database based on first configuration information that include information related to a location of the data in the source database; loading a set of preset routing rules; determining a target database and a target table based on the set of preset routing rules; and writing, by a write plug-in, the data into the target table in the target database based on second configuration information that include information related to a type of the target database and an identification of the target database.

Additional objects and advantages of the disclosed embodiments will be set forth in part in the following description, and in part will be apparent from the description, or may be learned by practice of the embodiments. The objects and advantages of the disclosed embodiments may be realized and attained by the elements and combinations set forth in the claims.

It is to be understood that both the foregoing general description and the following detailed description are exemplary and explanatory only and are not restrictive of the disclosed embodiments, as claimed.

### BRIEF DESCRIPTION OF THE DRAWINGS

FIG. 1 is a flow chart illustrating a data backflow process under the current technology.

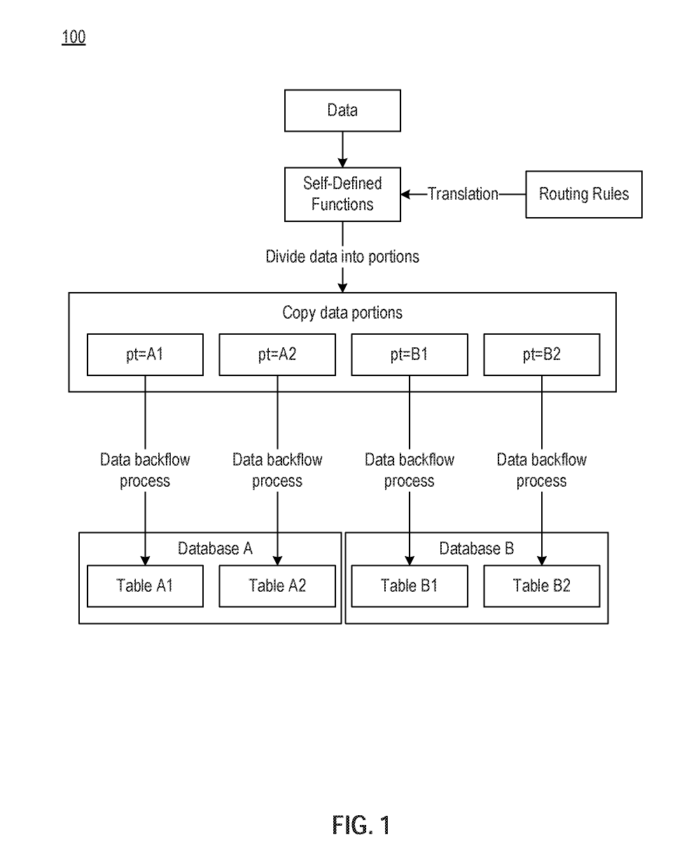

FIG. 2 is a flow chart illustrating a data transfer process consistent with embodiments of the present disclosure.

FIG. 3 is a block diagram of an offline synchronization apparatus consistent with embodiments of the present disclosure.

FIG. 4 is a flow chart illustrating a data backflow process consistent with embodiments of the present disclosure.

FIG. 5 is a block diagram of a data transfer apparatus consistent with embodiments of the present disclosure.

### DESCRIPTION OF THE EMBODIMENTS

Embodiments of the present disclosure provide a method and an apparatus for transferring data between a plurality of databases. An apparatus according to embodiments of the present disclosure include a read plug-in and a write plug-in. The apparatus may use the read plug-in to acquire data from a source database based on first configuration information that include information related to a source of data. The apparatus may also load a set of preset routing rules, and determine a target database and a target table based on the set of preset routing rules. The apparatus may also use a write plug-in to write the data into the target table in the target database based on second configuration information that include information related to a type of the target database and an identification of the target database.

With embodiments of the present disclosure, the writing of the data to target databases and target tables may be based on a reuse of previously-translated routing rules. As a result, the aforementioned translation of the routing rules into functions supported by the target database may be avoided, and data backflow operation may be substantially simplified. Moreover, since data is directly transferred to the database without being copied to new tables, as is the case under the current technology, database resources may be utilized more efficiently. Further, in some embodiments of the present disclosure, the data backflow operation may be configured using a single file, which may further simplify the data backflow process and reduce the likelihood of errors.

Reference will now be made in detail to methods and specific implementations that seek to overcome the foregoing shortcomings of current systems and methods for facilitating the login of an account. Examples of these implementations are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

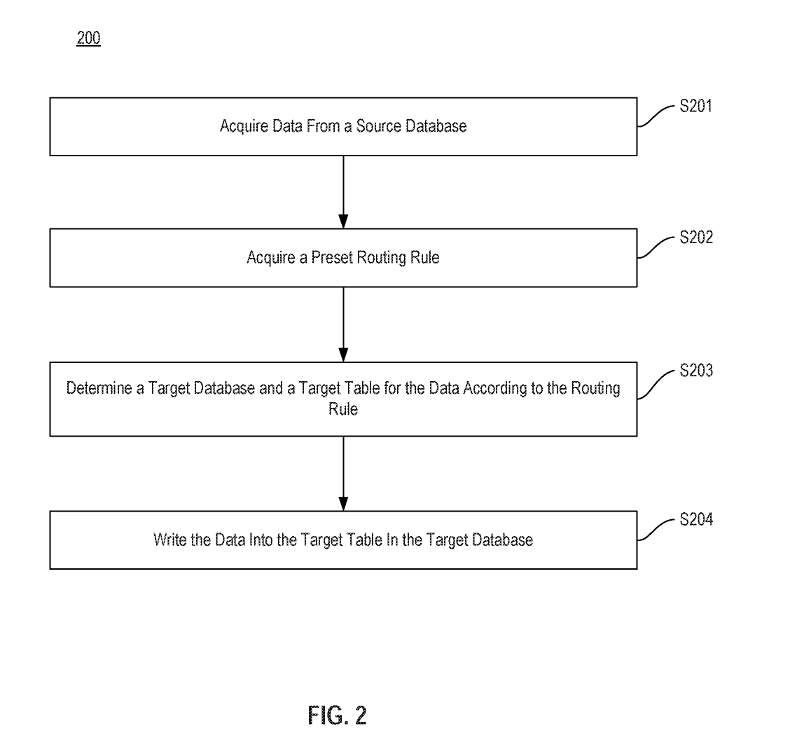

Reference is now made to FIG. 2, which illustrates an exemplary data transfer process method 200 according to embodiments of the present disclosure. The method may be performed by, for example, a computer system communicatively coupled with a plurality of databases. Referring to FIG. 2, method 200 includes steps S201, S202, S203, and S204.

In step S201, the system acquires data from a source device that includes a source database.

In a cloud computing platform, a large amount of data may be generated from daily operations. As an illustrative example, a platform associated with a large-scale e-commerce website may process about 300 TB of data related to products and transactions every day.

The platform generally processes the data according to a set of pre-determined rules to generate backflow data. For example, the e-commerce website may be configured to push different advertisements to different users. The determination of advertisement may be based on data related to the user's historical purchases, the user's activities on other websites, the user's personal information, etc. These data may be acquired from the source database and pushed to a target database associated with the website, which may then access these data to determine the advertisement to display.

In some embodiments, an off-line synchronization apparatus may be used to acquire data from the first data source. For a data size of 300 TB, about 60000 off-line synchronization operations may be required.

The cloud computing platform may include up to tens of thousands of computers and may operate on different types of databases, such as MySQL, Oracle, SQLServer, Hadoop, ODPS, ADS, Hbase, and the like. Therefore, an off-line synchronization apparatus according to embodiments of the present disclosure may perform synchronization between databases of different types.

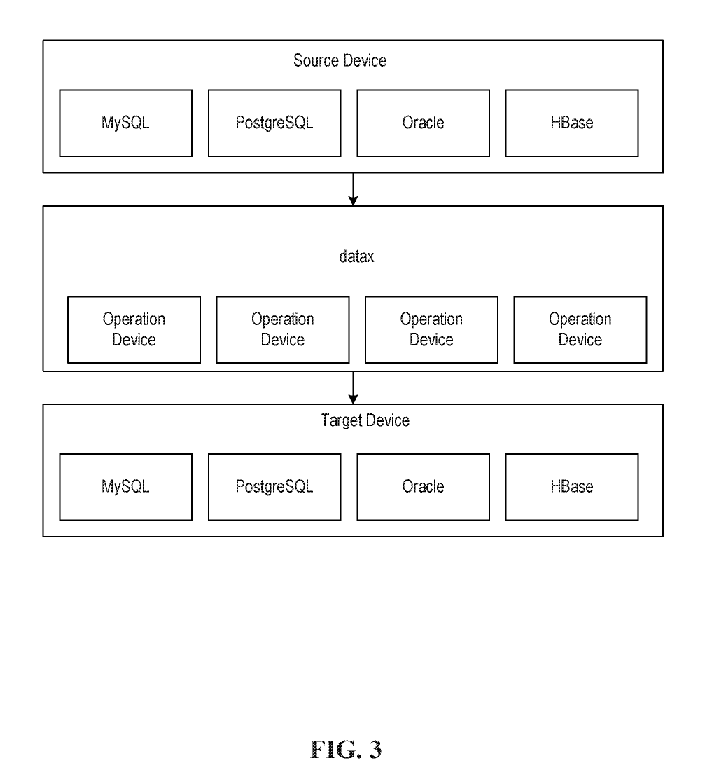

Reference is now made to FIG. 3, which illustrates an exemplary off-line synchronization apparatus 300 according to embodiments of the present disclosure. As shown in FIG. 3, an offline synchronization apparatus 300, such as Datax, may be used for synchronization between various databases. Datax may be written in the JAVA™ language, the C language, etc. and is not limited to the examples provided in this disclosure. Off-line synchronization apparatus 300 may include a plurality of operation devices, each of which may provide a data synchronization service (e.g., a Datax Service). For example, as part of the Datax Service, Datax may receive a command associated with a data flowback process (e.g., a start operation command, a stop operation command, etc.), select an operation device to execute the command, and then receive a status from the operation device. During data synchronization, the operation device may acquire the data from the source device and transfer the data to the target device. While FIG. 3 refers to Datax, it is appreciated that any type of offline synchronization apparatus can be used.

The source device and the target device may include any relational database or non-relational database, such as MySQL, Oracle, SQLServer, Hadoop, ODPS, ADS, PostgreSQL, and Hbase, which are not limited to the examples provided in this disclosure. Moreover, off-line synchronization apparatus 300 may perform data transmission between databases of different types. For example, an operation device may acquire data from a MySQL database and write the data into an Hbase databse. The source device may store data generated from a massive amount of data (e.g., data related to the user's historical purchases, the user's activities on other websites, the user's personal information, etc., as described in the illustrative examples above). The data may then be transferred to the target device in the off-line synchronization process for further processing, such as aggregation and classification. Therefore, the off-line synchronization may be part of the data backflow process.

In some embodiments, the source device may include a Reader (read plug-in) and a Writer (write plug-in) to access the Datax Service and to implement exchange of data between the source device and another target device.

In some embodiments, off-line synchronization apparatus 300 may execute a command in a form of a configuration file readable by the Datax Service. The configuration file may include, for example, a JavaScript Object Notation (JSON, a lightweight data interchange format) file, and the JSON configuration file may include a complete description file of a data backflow operation and may include configuration information of a Reader and a Writer.

The Datax may provide a Reader configured to acquire data from one or more databases, and a Writer that writes data into one or more databases.

The plug-ins (for the Reader and Writer) may be based on a plug-in model of the Datax, and may be loaded when Datax starts up. A plug-in may be associated with a specific type of data source. For example, a MySQLReader plug-in may represent that the Datax supports reading data from the MySQL database. In some embodiments, a read plug-in associated with a database in the source device may be selected from one or more read plug-ins, and a write plug-in associated with a database in the target device may be selected from one or more write plug-ins.

In some embodiments, the read plug-in may be configured with first configuration information, and the write plug-in may be configured with second configuration information. The first and second configuration information may include information for accessing a database, such as account identifiers, passwords, database identifiers, table identifiers, etc. Moreover, the second configuration information may also include the routing rules represented using Groovy expressions. Therefore, the Reader plug-in may be generated based on the configurations for a data backflow process as reflected in the routing rules, and that the plug-in of the configuration file (e.g., JSON configuration file as discussed above) may be of the same format as the routing rule. The configuration file may then be generated based on the first and second configuration information.

With embodiments of the present application, a single configuration file may be used to configure a data backflow process. As a result, the number of configurations may be substantially reduced, which may simplify the configuration process and reduce the probability of error.

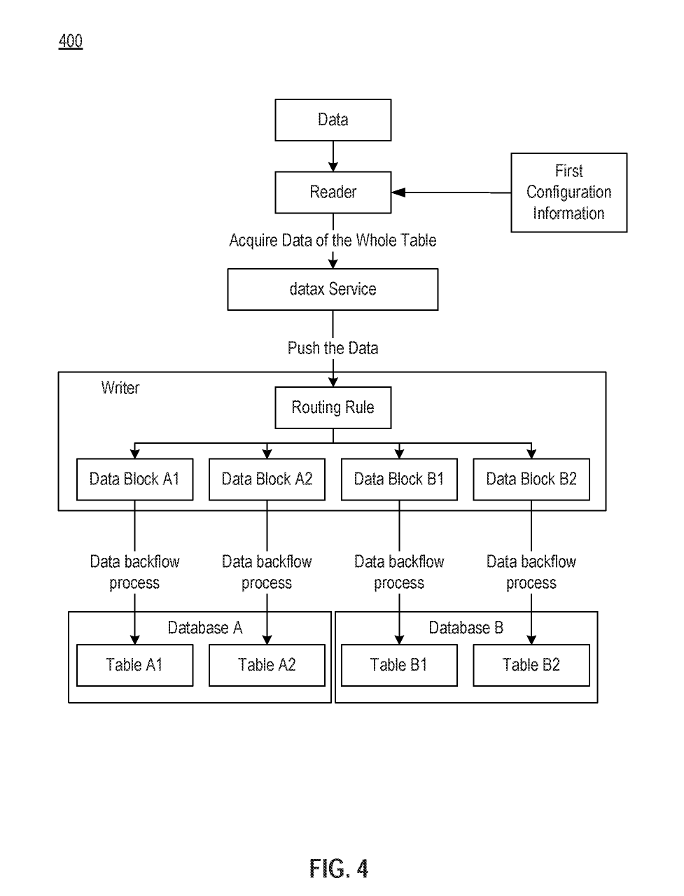

Reference is now made to FIG. 4, which illustrates an exemplary data backflow process 400 consistent with embodiments of the present disclosure. As shown in FIG. 4, first configuration information in a preset configuration file may be acquired by the Reader, which then acquires data from a source database according to the first configuration information. In one data backflow operation, the Reader generally acquires data of the whole table.

The first configuration information may include information about at least one of: an account identifier, a password, a project identifier, a table identifier, partition information, and column information. An example of the first configuration information of the Reader is illustrated as follows:

```
“reader”: {
                    “name”: “odpsreader”,
                    “parameter”: {
                        “accessId”: “accessId”,
                        “accessKey”: “accessKey”,
                        “project”: “targetProjectName”,
                        “table”: “tableName”,
                        “partition”: [
                            “pt=1,ds=hangzhou”
                        ],
                        “column”: [
                            “customer_id”,
                            “nickname”
                        ],
                        “odpsServer”: “odpsServer”
                    }
                }
```

As shown above, the first configuration information may include a project identifier (“targetProjectName”), a table identifier (tableName), partition information (“pt=1, ds=hangzhou”), and column information (“customer_id”, “nickname”) of an ODPS to be accessed, as well as an account identifier (“accessId”), and a password (“accessKey”) for accessing the ODPS. For example, the Reader may provide the accessId and accessKey information to log into an ODPS. After logging in, the Reader may locate a project in the database using the targetProjectName information, and then locate a partition and a column in that partition using the partition and column information. The Reader may then acquire the data in the column.

Referring back to FIG. 2, after step S201 is completed, the system may then proceed to step S202 to acquire a set of preset routing rules.

After the Reader completes acquisition of the data in step S202, the data may be pushed to the Writer by using the Datax Service. The Writer may then write the data into a table of a target database. In some embodiments, the writing of the data may be based on second configuration information, which may include information such as, for example, a plug-in name and a set of routing rules. As a result, the configuration file provides the routing rules information to the plug-in. In some embodiments, the routing rules refers to a manner of calculating determining a table and a database for writing the data, and may be directly copied from the routing rules maintained by the service system.

An example of the second configuration information of the Writer is illustrated as follows:

```
“writer”: {
    “name”: “dbwriter”,
    “parameter”: {
        “rule” : “ groovy expression”,
        “column”: [
            “id”
        ],
        “connection”: [
            {
                “jdbcUrl”: “jdbc:mysql://1.1.1.1:3306/A”,
                “table”: [
                    “A1”,“A2”
                ]
            },
            {
                “jdbcUrl”: “jdbc:mysql://1.1.1.1:3306/B”
                “table”: [
                    “B1”,“B2”
                ]
            }
        ]
    }
}
```

In this example above, the name of the plug-in is “dbwriter”, and the routing rules are represented by the Groovy expressions.

In step S203,the system may determine a target database and a target table for the writing of the data from a plurality of pre-configured databases and tables.

As discussed above, under current technology, the routing rules are generally represented in Groovy expressions. On the other hand, systems such as Hadoop typically do not support Groovy expressions; as a result, the routing rules represented by Groovy expression are translated into self-defined functions that are supported by Hadoop.

In contrast, in the embodiments of the present application, Datax, an off-line synchronization apparatus, is independent from the cloud computing platform, and may support and understand the Groovy expressions. Therefore, the routing rules in Groovy expressions may be provided to the Datax.

An example of the routing rule is illustrated as follows:

“tableNamePattern”:mysql_writer_test_case_{000}”
“tableRule” : “((#id#).longValue( ) % 8)”

Here, the “tableNamePattern” may be a table name placeholder expression, while “tableRule” may refer to a routing rule associated with the table. The input to the “#id#.longValue( )% 8” expression may be a routing field value, and an output value directly replaces the “000” in the table name placeholder expression.

For example, a value of the “id” field may be 5,which represents that a routing field value is calculated to be 5. In this case, the table name placeholder expression may become “mysql_writer_test_case_005” where “005” replaces the “000” in the expression.

In step S204, the system writes the data into a target table in a target device that includes the target database.

In some embodiments, the second configuration information for the Writer plug-in may include configuration information (“Connection”) for one or more databases, the paths associated with these databases (“jdbcUrls”), the tables, etc. When the second configuration information includes information for a plurality of databases and/or tables, the system may determine that the data backflow process is for transmitting data to a plurality of databases and tables. When the second configuration information includes information for a single database and a single table, the system may determine that the data backflow process is for transmitting data to a single database and to a single table.

The system may then determine, from the second configuration information, configuration information associated with the one or more databases (Connection), such as jdbcUrl (database path), account identifier (userName), password, and column information. The system may log into a target database associated with the database path jdbcUrl (database path) using the account identifier (userName) and the password, and then write the data into a column of a target table based on the column information.

In order to improve the writing speed of data, data may be written in batches. To facilitate the batch writing of data, the Writer may include a buffer that includes a number of data blocks. The number of data blocks may be identical to a number of target tables, and each data block may correspond to a target table. When a preset write condition is satisfied, the Writer may write the data into a buffer data block that corresponds to the target table of the target database.

For example, as shown in FIG. 4, a data block A1 stores data of the table A1 in the database A, a data block A2 stores data of the table A2 in the database A, a data block B1 stores data of the table B1 in the database B, and a data block B1 stores data of the table B2 in the database B. When the preset write condition is met, the data of the data block A1 may be written into the table A1, the data of the data block A2 may be written into the table A2, the data of the data block B1 may be written into the table B1, and the data of the data block B2 may be written into the table B2.

In some embodiments, the write condition that triggers the writing of data to a target table may include a data size condition. For example, the data in the data block may be written into the target table in the target database when the data size in the data block exceeds a preset data size threshold (for example, 32 MB).

In some embodiments, the write condition that triggers the writing of data to a target table may include a quantity condition. For example, the data in the data block may be written into the target table in the target database when the data in the data block include a number of items that exceeds a preset quantity threshold (for example, 2048 pieces).

In some embodiments, the write condition that triggers the writing of data to a target table may include a complete condition. For example, the data in the data block may be written into the target table in the target database when the Reader completes acquisition of data.

Under the current technology, as part of the data backflow process, the data is divided into portions for each new table and each database that includes the table, and then the data portions are copied into the new tables, and database resources may be wasted as a result. To address the inefficient utilization of database resources, the Writer according to embodiments of the present disclosure may determine, based on the routing rules in the memory, which of the tables and databases to which the data are to be written to. The Writer may then directly write the data into the tables and databases without having to recopy data. As a result, the utilization of database resources may become more efficient.

Further, the Writer may support multiples types of databases. For a unified write operation, the second configuration information of the configuration file may specify a type of the target database. For example, the second configuration information may specify “MySQLWriter” for a Writer for MySQL, and “OracleWriter” for a Writer for Oracle, etc.

The Writer may invoke a pre-configured database connection interface (JDBC, Java Data Base Connectivity) according to the type of the database specified in the second configuration information to write the data into the target table in the target database of the specified type. The JDBC is a Java API used for executing SQL statements. JDBC may include a group of categories and interfaces written in the Java language and may cover operations of multiple databases to provide a unified access for various types of databases. With embodiments of the present disclosure, components of the Datax Service may be reused to provide data backflow to different tables and databases.

With embodiment of the present application, the information for target table and target database may be determined based on a set of pre-stored routing rules without the need of translation to a format supported by the database; as a result, the data backflow operation may be substantially simplified. Moreover, the data may be directly written into the tables and databases based on the routing rules without the need of recopying. As a result, the utilization of database resources may become more efficient.

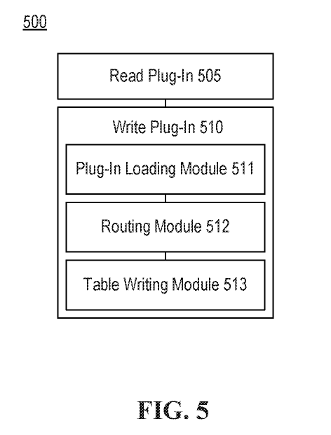

Reference is now made to FIG. 5, which illustrates a data transfer apparatus 500 consistent with embodiments of the present disclosure. In some embodiments, data transfer apparatus 500 may be configured to implement method 200 of FIG. 2. As shown in FIG. 5, data transfer apparatus 500 includes a read plug-in 505 and a write plug-in 510.

The read plug-in 505 is configured to acquire data from a source database. In some embodiments, read plug-in 505 may be configured to perform at least step S201 of FIG. 2.

The write plug-in 510 may include the following modules: a plug-in loading module 511, a routing module 512, and a table writing module 513.

Plug-in loading module 511 is configured to load a set of preset routing rules. In some embodiments, plug-in loading module 511 may be configured to perform at least step S202 of FIG. 2.

Routing module 512 may be configured to determine a target database and a target table for the data based on the routing rules acquired by plug-in loading module 511. In some embodiments, routing module 512 may be configured to perform at least step S203 of FIG. 2.

Table writing module 513 may be configured to determine the data for the target table in the target database. In some embodiments, table writing module 513 may be configured to perform at least step S204 of FIG. 2.

In some embodiments, read plug-in 505 may include the following modules:

a first configuration information reading module, configured to read first configuration information of the read plug-in in a preset configuration file; and

a database reading module, configured to read data from the source database according to the first configuration information.

In a specific implementation, the first configuration information may include at least one of an account, a password, a project, a table, a partition, and a column; and

the database reading module may include the following sub-modules:

a connecting sub-module, configured to connect the source database by using the account and the password;

a searching sub-module, configured to: when the connection is successful, search for the table in the project in the source database, search for the partition in the table, and search for the column in the partition; and

a column reading sub-module, configured to read data from the column.

In some embodiments, the plug-in loading module 511 may include a second configuration information acquisition sub-module configured to acquire, from a preset configuration file, the second configuration information for the write plug-in. The second configuration information may comprise the routing rules, and configuration information of one or more databases.

In some embodiments, table writing module 513 may include a configuration information searching sub-module configured to search for configuration information corresponding to the target database, and a writing sub-module configured to write the data into the target table in the target database according to the configuration information.

In some embodiments, table writing module 513 may also a data block writing sub-module configured to write the data into a buffer data block that corresponds to in a target table in a target database, and a data block backflow sub-module configured to write the data in the data block into the target table in the target database.

In some embodiments, the data block backflow sub-module of table writing module 513 may further comprise at least one of: a first backflow sub-module configured to write the data in the data block into the target table in the target database when the size of the data in the data block exceeds a preset data size threshold; a second backflow sub-module configured to write the data in the data block into the target table in the target database when the a number of data items included in the data in the data block exceeds a preset quantity threshold; and a third backflow sub-module configured to write the data in the data block into the target table in the target database when acquisition of data (e.g. by reader plug-in) is completed.

In some embodiments, the table writing module 513 may include the following sub-modules: a database type identifying sub-module configured to identify a type of the target database, and an interface invoking sub-module configured to invoke a pre-configured database connection interface according to the type of the database to write the data into the target table in the target database.

In some embodiments, data transfer apparatus 500 may further include the following modules: a read plug-in selecting module configured to select, from one or more read plug-ins, a read plug-in associated with a source database; a write plug-in configured to select, from one or more write plug-ins, a write plug-in associated with a target database; and a plug-in configuring module configured to generate the first configuration information for the read plug-in and the second configuration information (which also include the routing rules) for the write plug-in.

As will be understood by those skilled in the art, embodiments of the present disclosure may be embodied as a method, a system or a computer program product. Accordingly, embodiments of the present disclosure may take the form of an entirely hardware embodiment, an entirely software embodiment or an embodiment combining software and hardware. Furthermore, the present invention may take the form of a computer program product embodied in one or more computer available storage media (including but not limited to a magnetic disk memory, a CD-ROM, an optical memory and so on) containing computer available program codes.

Embodiments of the present disclosure are described with reference to flow diagrams and/or block diagrams of methods, devices (systems) and computer program products according to embodiments of the present invention. It will be understood that each flow and/or block of the flow diagrams and/or block diagrams, and combinations of flows and/or blocks in the flow diagrams and/or block diagrams, and the modules and sub-modules of the apparatus, may be implemented by computer program instructions. These computer program instructions may be provided to a processor of a general-purpose computer, a special-purpose computer, an embedded processor, or other programmable data processing devices to produce a machine, such that the instructions, which are executed via the processor of the computer or other programmable data processing devices, create a means for implementing the functions specified in one or more flows in the flow diagrams and/or one or more blocks in the block diagrams.

These computer program instructions may also be stored in a computer readable memory that may direct a computer or other programmable data processing devices to function in a particular manner, such that the instructions stored in the computer readable memory produce a manufactured product including an instruction means which implements the functions specified in one or more flows in the flow diagrams and/or one or more blocks in the block diagrams.

These computer program instructions may also be loaded onto a computer or other programmable data processing devices to cause a series of operational steps to be performed on the computer or other programmable devices to produce processing implemented by the computer, such that the instructions which are executed on the computer or other programmable devices provide steps for implementing the functions specified in one or more flows in the flow diagrams and/or one or more blocks in the block diagrams.

In a typical configuration, a computer device includes one or more Central Processing Units (CPUs), an input/output interface, a network interface and a memory.

The memory may include forms of a volatile memory, a random access memory (RAM) and/or non-volatile memory and the like, such as a read-only memory (ROM) or a flash RAM in a computer readable medium. The memory is an example of the computer readable medium.

The computer readable medium includes non-volatile and volatile media, removable and non-removable media, wherein information storage may be implemented with any method or technology. Information may be modules of computer readable instructions, data structures and programs or other data. Examples of a computer storage medium include, but are not limited to, a phase-change random access memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a compact disc read-only memory (CD-ROM), a digital versatile disc (DVD) or other optical storage, a cassette tape, tape or disk storage or other magnetic storage devices or any other non-transmission media which may used to store information capable of being accessed by a computer device. According to the definition of the context, the computer readable medium does not include transitory media, such as modulated data signals and carrier waves.

It will be further noted that the terms “comprises”, “comprising” or any other variations are intended to cover non-exclusive inclusions, so as to cause a process, method, commodity or device comprising a series of elements to not only comprise those elements, but also comprise other elements that are not listed specifically, or also comprise elements that are inherent in this process, method, commodity or device. Therefore, the element defined by a sentence “comprising a...” does not preclude the presence of other same elements in the process, method, commodity or device including said elements under the condition of no more limitations.

As will be understood by those skilled in the art, embodiments of the present invention may be embodied as a method, a system or a computer program product. Accordingly, the present invention may take the form of an entirely hardware embodiment, an entirely software embodiment or an embodiment combining software and hardware. Furthermore, the present invention may take the form of a computer program product embodied in one or more computer available storage media (including but not limited to a magnetic disk memory, a CD-ROM, an optical memory and so on) containing computer available program codes.

One of ordinary skill in the art will understand that the above described embodiments may be implemented by hardware, or software (program codes), or a combination of hardware and software. If implemented by software, it may be stored in the above-described computer-readable media. The software, when executed by the processor may perform the disclosed methods. The computing units and the other functional units described in this disclosure may be implemented by hardware, or software, or a combination of hardware and software. One of ordinary skill in the art will also understand that multiple ones of the above described modules/units may be combined as one module/unit, and each of the above described modules/units may be further divided into a plurality of sub-modules/sub-units.

Other embodiments of the present disclosure will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes may be made without departing from the scope thereof. It is intended that the scope of the invention should only be limited by the appended claims.

What is claimed is:

1. A method of transferring data between a plurality of databases, comprising:
acquiring, by a read plug-in, data from a source database based on first configuration information that include information related to a location of the data in the source database;
loading a set of preset routing rules;
determining a target database and a target table based on the set of preset routing rules; and
writing, by a write plug-in, the data into the target table in the target database based on second configuration information that include information related to a type of the target database and an identification of the target database.

2. The method according to claim 1, wherein the acquiring of data from a source database based on first configuration information comprises:
reading the first configuration information of the read plug-in from a preset configuration file.

3. The method according to claim 1, wherein the first configuration information further comprises an account identifier, a password, a project identifier, a table identifier, partition information, and column information; and
wherein the acquiring the data from the source database based on first configuration information further comprises:
logging into the source database using the account identifier and the password;
if the logging is successful:
searching for a table in the project in the source database based on the table identifier,
searching for the partition in the table based on the partition information,
searching for a column in the partition based on the column information, and
acquiring the data from the column.

4. The method according to claim 1, wherein the loading a set of preset routing rules further comprises:
acquiring the second configuration information of the write plug-in, wherein the second configuration information comprises the routing rule.

5. The method according to claim 4, wherein the second configuration information further includes configuration information of one or more databases;
wherein the writing the data into the target table in the target database further comprises:
searching, from the second configuration information, configuration information corresponding to the target database; and
writing the data into the target table in the target database according to the configuration information corresponding to the target database.

6. The method according to claim 1, wherein the writing the data into the target table in the target database further comprises:
writing, into a memory, the data into a data block that corresponds to the target table in the target database; and
writing the data in the data block into the target table in the target database.

7. The method according to claim 6, wherein the data in the data block is writing the target table when a condition is satisfied, wherein the condition comprises at least one of:
a size of the data in the data block exceeds a preset data size threshold;
a number of items in the data in the data block exceeds a preset quantity threshold; and
that the acquisition of data by the read plug-in has completed.

8. The method according to claim 1, wherein the writing the data into the target table in the target database further comprises: invoking a pre-configured database connection interface based on the information related to a type of the target database.

9. The method according to claim 1, further comprising:
selecting the read plug-in from a plurality of read plug-ins, wherein the selected read plug-in is associated with the source database; and
selecting the write plug-in from a plurality of write plug-ins, wherein the selected write plug-in is associated with the target database.

10. An apparatus for transferring data between a plurality of databases, the apparatus comprising:
a memory that stores a set of instructions; and
at least one hardware processors configured to execute the set of instructions to:
acquire, by a read plug-in, data from a source database based on first configuration information that include information related to a location of the data in the source database;
load a set of preset routing rules;
determine a target database and a target table based on the set of preset routing rules; and
write, by a write plug-in, the data into the target table in the target database based on second configuration information that include information related to a type of the target database and an identification of the target database.

11. The apparatus according to claim 10, wherein the first configuration information further comprises an account identifier, a password, a project identifier, a table identifier, partition information, and column information; and
wherein the acquiring the data from the source database based on first configuration information further comprises the at least one hardware processor being configured to execute the set of instructions to:
log into the source database using the account identifier and the password;
if the logging is successful:
search for a table in the project in the source database based on the table identifier,
search for the partition in the table based on the partition information,
search for a column in the partition based on the column information, and
acquire the data from the column.

12. The apparatus according to claim 10, wherein the loading a set of preset routing rules further comprises the at least one hardware processor being configured to execute the set of instructions to:
acquire the second configuration information of the write plug-in, wherein the second configuration information comprises the routing rule.

13. The apparatus according to claim 12, wherein the second configuration information further includes configuration information of one or more databases;
wherein the writing the data into the target table in the target database further comprises the at least one hardware processor being configured to execute the set of instructions to:
search, from the second configuration information, configuration information corresponding to the target database; and
write the data into the target table in the target database according to the configuration information corresponding to the target database.

14. The apparatus according to claim 10, wherein the writing the data into the target table in the target database further comprises the at least one hardware processor being configured to execute the set of instructions to:
write, into a memory, the data into a data block that corresponds to the target table in the target database; and
write the data in the data block into the target table in the target database.

15. The apparatus according to claim 14, wherein the data in the data block is writing the target table when a condition is satisfied, wherein the condition comprises at least one of:
a size of the data in the data block exceeds a preset data size threshold;
a number of items in the data in the data block exceeds a preset quantity threshold; and
that the acquisition of data by the read plug-in has completed.

16. The apparatus according to claim 11, wherein the writing the data into the target table in the target database further comprises the at least one hardware processor being configured to execute the set of instructions to:
invoke a pre-configured database connection interface based on the information related to a type of the target database.

17. A non-transitory computer readable medium that stores a set of instructions that is executable by at least one processor of an apparatus to cause the apparatus to perform a method for transferring data between a plurality of databases, the method comprising:
acquiring, by a read plug-in, data from a source database based on first configuration information that include information related to a location of the data in the source database;
loading a set of preset routing rules;
determining a target database and a target table based on the set of preset routing rules; and
writing, by a write plug-in, the data into the target table in the target database based on second configuration information that include information related to a type of the target database and an identification of the target database.

18. The non-transitory computer medium according to claim 17, wherein the first configuration information further comprises an account identifier, a password, a project identifier, a table identifier, partition information, and column information; and
wherein the acquiring the data from the source database based on first configuration information further comprises the non-transitory computer readable medium storing the set of instructions that is executable by at least one processor of an apparatus to cause the apparatus to further perform:
logging into the source database using the account identifier and the password;
if the logging is successful:
searching for a table in the project in the source database based on the table identifier,
searching for the partition in the table based on the partition information,
searching for a column in the partition based on the column information, and
acquiring the data from the column.

19. The non-transitory computer readable medium according to claim 17, wherein the loading a set of preset routing rules further comprises the non-transitory computer readable medium storing the set of instructions that is executable by at least one processor of an apparatus to cause the apparatus to further perform:
acquiring the second configuration information of the write plug-in, wherein the second configuration information comprises the routing rule.

20. The non-transitory computer readable medium according to claim 19, wherein the second configuration information further includes configuration information of one or more databases;
wherein the writing the data into the target table in the target database further comprises the non-transitory computer readable medium storing the set of instructions that is executable by at least one processor of an apparatus to cause the apparatus to further perform:
searching, from the second configuration information, configuration information corresponding to the target database; and
writing the data into the target table in the target database according to the configuration information corresponding to the target database.

21. The non-transitory computer readable medium according to claim 17, wherein the writing the data into the target table in the target database further comprises the non-transitory computer readable medium storing the set of instructions that is executable by at least one processor of an apparatus to cause the apparatus to further perform:
writing, into a memory, the data into a data block that corresponds to the target table in the target database; and
writing the data in the data block into the target table in the target database.

22. The medium according to claim 21, wherein the data in the data block is writing the target table when a condition is satisfied,
wherein the condition comprises at least one of:
a size of the data in the data block exceeds a preset data size threshold;
a number of items in the data in the data block exceeds a preset quantity threshold; and
that the acquisition of data by the read plug-in has completed.
